(19) United States
(12) Patent Application Publication
(10) Pub. No.: US 2003/0182206 A1
(43) Pub. Date: Sep. 25, 2003

(54) Accounts payable electronic processing

(76) Inventors: Thomas R. Hendrix, Louisville, KY (US); Patricia Slone Peet, Louisville, KY (US); Natalie Coley Burden, Elizabethtown, KY (US); Brian Scott Mattingly, Mount Washington, KY (US); Harry Arnold James, Louisville, KY (US); Ernest L. Kuhn, Louisville, KY (US); Deborah Louise McDevitt, Louisville, KY (US); Kristy Rose Leonard, Louisville, KY (US); James W. Grimes, Shepherdsville, KY (US); Rebecca Lynn Woodrow, Louisville, KY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/382,707

(22) Filed: Mar. 6, 2003

Related U.S. Application Data
(60) Provisional application No. 60/363,026, filed on Mar. 7, 2002.

(51) Int. Cl. G06F 17/60

(52) U.S. Cl. 705/26

(57) ABSTRACT

Computerized method and system for an entire enterprise's intelligent management of accounts payable electronic processing are provided. All functions (e.g., Servicers, direct ship parts, e-time, e-logistics, and e-invoicing, etc.) across the enterprise are integrated into comprehensive, robust electronic automation of all domestic and international business transaction types (i.e., all internal and external suppliers) yielding a total payables solution. A database provides storage of accounts payable data for each of a plurality of purchase transactions. Rule-based logic and expert system validation checks are performed to ensure compliance and accuracy. A plurality of Web pages including hyperlinks is configured to link over a communications network to an enterprise managed Web site enabling authorized account access to the system. The system offers suppliers on-line, interactive self-help and remittance advice. The system also provides various types of electronic data formats to support supplier automation. An enterprise may “open” a Purchase Order (PO) in support of a business transaction and notifies the assigned supplier of this action. The supplier accesses online their account to obtain PO information. The supplier provides the goods/services accordingly. Electronic receipt of goods is acknowledged and/or an electronic invoice (e-invoice) is generated, (e.g., e-invoicing enables automated cost verification). Settlement may be validated by the rule-based expert system checks and accomplished via electronic means. Upon settlement, the PO is closed and the transaction completed.

This application claims priority to a provisional application filed on Mar. 7, 2002, having application Ser. No. 60/363,026, which is incorporated herein by reference.

### BACKGROUND OF THE INVENTION

The present invention is generally related to E-commerce (electronic commerce) system and techniques, and, more particularly, to computerized method and system for managing the processing and settlement of accounts payable.

Traditional manual methods for collecting, reviewing, and paying invoices is: costly, time consuming, and laden with errors especially for enterprises supporting a large volume of transactions from a variety of sources. On a business-wide (i.e., enterprise) scale, solutions are typically limited, being partially automated and independent of each other. Separate solutions only meet a particular department's requirements. Each department or business unit may support network communications between the units, but possess separate database systems within different departments. Thus, intercommunications between departments are essentially manual processes. This fragmented costly approach requires iterative data entry resulting in errors.

E-commerce, the use of a computer network, such as the Internet, to conduct business (e.g., buy and sell products and/or services), streamlines and automates business transactions without the burden and costs associated to paperwork making it well-suited for enterprise operations. However, current E-commerce solutions are very limited and mostly consumer-oriented, managing each transaction as an isolated event instead of on-going business. Other problems exist with current E-commerce solutions. Prior art discloses the creation and submission of bills, invoices, and vouchers but these solutions are not intelligent and are targeted for very narrow, specific applications leading to another fragmented approach for an enterprise. By way of example, consider U.S. Pat. No. 6,292,789 to Schutzer entitled “Method and System for Bill Presentment and Payment” which consists of a billing system that solely communicates bills to end-consumers electronically. This system does not address any other accounts payable needs.

Another method utilizing an electronic billing system is described in U.S. Pat. No. 6,304,857 to Heindel, entitled “Distributed Electronic Billing System with Gateway Interfacing Biller and Service Center.” This patent discloses a billing system that consists of a network-based process; however, it is positioned for third party services targeting consumers, not for the enterprise to incorporate these functions into their business operations. This process leverages costly EDI (Electronic Data Interchange) services. EDI services provide a collection of standard message formats for computer-to-computer or to exchange data via an electronic messaging service. This process would not reduce costs nor automate the billing process for an enterprise but merely outsource some billing functions to a costly service. The enterprise would still be required to support internal and some external accounts payable operations/functions.

### BRIEF SUMMARY OF THE INVENTION

Reducing costs is essential for an enterprise to remain competitive and conduct business at a global scale. Thus, it would be desirable for an enterprise to mitigate errors and eliminate the labor intense fragmented paper approach to accounts payable. It would be further desirable to replace these fragmented solutions with an automated, cost-effective, intelligent solution providing efficient electronic access to a central data repository. This automated solution could fulfill requirements for supporting a plurality of supplier and vendor types comprising of internal, external, services, and/or products for both domestic and international business transactions. This automated, centralized solution would allow an enterprise, such as the assignee of the present invention, to more efficiently and cost-effectively manage financial operations.

Generally, the present invention fulfills the foregoing needs by providing in one aspect thereof a comprehensive computerized method and system for an entire enterprise's electronic processing of accounts payable. This cohesive intelligent management of the accounts payable allows for integration of numerous functions across the enterprise into robust electronic automation of all domestic and international business transaction types (i.e., all internal and external suppliers)—a total payables solution. This method and system allows an electronic means to be embraced, minimizing operational costs by eliminating the burdensome erroneous paper process. Accessibility is provided 24/7 to the intelligent, rule-based expert processing utilizing ubiquitous Internet/Web services instead of the costly EDI services. The method and system includes a database configured for storage of respective accounts payable data for each service transaction. A Purchase Order (PO) identifier may be used to uniquely associate each respective transaction to data such as service provider information, total costs authorized, authorization data, pertinent dates, description data of goods and/or services, quantities, and associated terms and conditions. Rule-based logic and expert system validation checks are performed to ensure compliance and accuracy. The method and system further provides Web pages including hyperlinks configured to link over a communications network to a SupplierNet system. The SupplierNet system is an enterprise-managed Web site enabling authorized account access to the intelligent, rule-based electronic accounts payable system and its associated data. The SupplierNet system offers suppliers on-line, interactive self-help (e.g., aids the supplier in the generation of an e-invoice) and remittance advice (e.g., the supplier can query the on-line database for presentment of the status of an e-invoice). The system provides various types of electronic data formats to support supplier automation. An enterprise purchasing system issues (i.e. opens) a PO in support of a business purchase transaction and notifies the assigned supplier of this action. The supplier can access their account by successfully logging into the SupplierNet system to obtain PO presentment. The supplier (e.g., a vendor) provides agreed upon goods/services. Electronic acknowledgement of goods/services (i.e., receipt of goods) is provided over the communications network and/or an electronic invoice (e-invoice) is generated utilizing the SupplierNet system (e-Invoicing enables automated cost verification). Settlement is validated by the rule-based expert system checks/matches and accomplished via electronic means such as electronic funds transfer (EFT), wire, P-Card, etc. Upon settlement, the PO is closed and the purchase transaction completed.

In one aspect thereof, the present invention provides a computerized method for managing payment of products and/or services acquired by a purveyor of goods through respective purchase transactions with a plurality of generally independent entities transacting in commerce with the purveyor of goods. The method allows reading a purchase order from a respective entity for a purchase transaction of respective products and/or services from that entity. The purchase order may be issued to the respective entity over a communications network. A database is populated with rules prescribing the payment or lack thereof for each purchase transaction based on whether the respective products and/or services being purchased actually fulfill purchase terms applicable to each purchase transaction. A user-interface is configured for each respective entity to supply invoice data over said communications network. The invoice data is arranged in a plurality of data fields. Some of the data fields may be preset in response to the respective purchase terms applicable to any given transaction and avoid introducing incorrect invoice data. Fulfillment data indicative of whether respective products and/or services being delivered and/or yet to be delivered actually meet the respective purchase terms applicable to each respective purchase transaction is collected. The database with rules prescribing the payment or lack thereof for each purchase transaction is accessed in view of the fulfillment data for each respective purchase transaction. The supplied invoice data is related to the fulfillment data and to the rules prescribing the payment or lack thereof for each purchase transaction to determine an appropriate action regarding each respective invoice. In the event the fulfillment data matches the payment rules for that purchase transaction, payment is processed for the entity based on the invoice data. In the event the fulfillment data indicates deviations from the payment rules for that transaction, a notice is issued to that user to correct the deviations.

In another aspect of the present invention, a computerized method for cohesively managing account payables accrued by a purveyor of goods through a plurality of distinct types of business transactions with a plurality of generally independent entities transacting with the purveyor of goods is provided. The method allows providing a plurality of distinct transaction-processing modules, each configured to process a distinct type of business transaction that may arise in the operations of a purveyor of the goods. A database is populated with rules prescribing the payment or lack thereof for each distinct type of business transaction based on whether transaction-fulfillment terms applicable to each distinct transaction are met. A user-interface is configured for each respective entity to supply invoice data over a communications network. The invoice data is arranged in a plurality of data fields that may be preset in response to reflect respective contractual terms applicable to any given type of transaction and avoid introducing incorrect invoice data. Transaction-fulfillment data is collected. The fulfillment data is indicative of whether respective products and/or services covered by respective ones of said distinct types of business transactions actually meet the respective contractual terms applicable to each distinct transaction. Each distinct transaction-processing module is coupled to share a common accounts payables module for accessing the database with rules prescribing the payment or lack thereof for each distinct type of transaction in view of the fulfillment data for each respective distinct transaction. The accounts payables module is configured to relate the supplied invoice data relative to the fulfillment data and to the rules prescribing the payment or lack thereof for each distinct type of transaction to determine an appropriate action regarding disposition of each respective invoice. An accounts payables database may be configured in the accounts payable module to provide to each entity respective status of account information regarding any distinct types of business transactions transacted by any respective entity with the purveyor of the goods. The accounts payables database may be available to each entity through the communications network.

### BRIEF DESCRIPTION OF THE DRAWINGS

The features and advantages of the present invention will become apparent from the following detailed description of the invention when read with the accompanying drawings in which:

FIG. 1 is a schematic illustration of a computerized accounts payable electronic processing system in accordance with aspects of the present invention.

FIG. 2 depicts an exemplary functional block diagram of core processing modules of the computerized accounts payable electronic processing system.

FIGS. 3-6 illustrate exemplary accounts payable modules comprising various types of inputs and settlement types.

FIG. 7 depicts an exemplary Web page of an invoice summary including respective hyperlinks for linking users of the system of FIG. 1 over a communications network.

FIG. 8 depicts an exemplary domestic processing flow diagram embodying aspects of the present invention.

FIG. 9 depicts an exemplary international processing flow diagram embodying other aspects of the present invention.

FIG. 10 illustrates an exemplary accounts payable system Web page supporting the generation of an electronic invoice.

FIGS. 11 and 12 further illustrate subsequent Web page of FIG. 10 for electronic invoice generation.

FIG. 13, collectively made up of FIGS. 13A through 13C, shows illustrative electronic invoice generation process flow diagram(s) of exemplary actions for the generation of an electronic invoice.

FIG. 14 is an illustrative block diagram detailing elements of a Temporary Labor module.

FIG. 15 illustrates an exemplary Web page including respective hyperlinks for linking users of the system of FIG. 1 over a communications network.

FIG. 16 illustrates an exemplary electronic time sheet prior to being filled by a service provider.

FIG. 17 illustrates an exemplary electronic time sheet as may be presented to an appropriate manager for review and approval.

FIG. 18 illustrates the electronic time sheet of FIG. 17, as that time sheet may appear in the event the manager grants approval thereof.

FIG. 19 illustrates the time sheet of FIG. 17 as may appear subsequent to submittal by the timekeeper but prior to approval by the responsible manager.

FIG. 20 illustrates a flow chart of exemplary actions that may occur during the approval process for the electronic time sheet.

FIG. 21 illustrates an exemplary electronic invoice as may be automatically generated based on the billable time on the approved time sheet and on the billing profile of the service provider.

FIG. 22 is a schematic that illustrates concepts that allow tracking each container as that container moves along the distribution chain, and further allows relating physical shipment information for each container to supplier e-invoice information for that container.

FIG. 23 is an illustrative block diagram detailing elements of the e-logistics module.

FIG. 24 is an exemplary flow relating multiple receivers involved in the distribution chain to a common Master Shipper Number.

### DETAILED DESCRIPTION OF THE INVENTION

The disclosed invention is a comprehensive solution that incorporates numerous enterprise (i.e., a business organization) functions resulting in robust automation of every business transaction type for an entire complex enterprise. The electronic means embraced minimizes operational costs by eliminating burdensome erroneous paper processing. Anything an enterprise would pay for is encompassed in this cohesive intelligent management of the accounts payable electronic processing system.

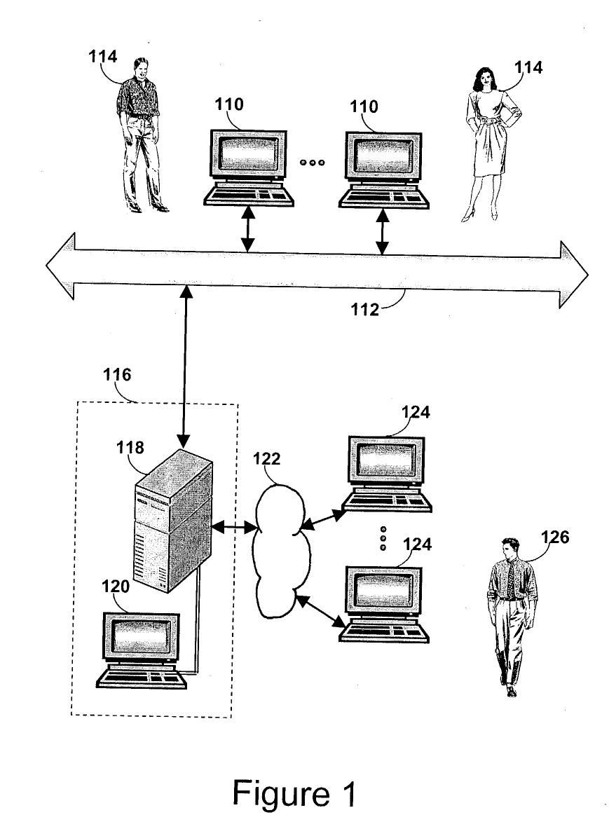

FIG. 1 illustrates an exemplary embodiment of an enterprise's computerized accounts payable electronic processing system where the accounts payable electronic processing system 116 accommodates any generic services and supports any transactions in a business setting. Suppliers 114 (e.g., service providers and/or purveyors of goods) external to the enterprise communicate with the accounts payable electronic processing system 116 using computerized systems 110 connected to the ubiquitous Internet 112. The enterprise's accounts payable electronic processing system 116 is comprised of a computational solution (e.g., a desktop computer connected to a mainframe, or a server 118 connected to a personal computer 120, etc.) communicating via connections to the Internet 112 and Intranet 122. Internal suppliers 124 gain access to the computerized accounts payable electronic processing system 116 via the enterprise Intranet 122 along with enterprise support staff such as a first manager 126. One convenient medium for internal suppliers, external suppliers, and enterprise personnel to access the accounts payable electronic processing system 116 constitutes the utilization of a Web site operated and managed by the assignee of the present invention referred to as the SupplierNet system. Suppliers, both internal and external, utilize their unique Web account for on-line interactive communications with the SupplierNet system. It will be appreciated, however, that the Internet/Intranet configuration is just one example of a communications network that would allow users (e.g., a supplier) to conveniently access the SupplierNet system since, other communication networks could be used depending on the requirements of any given application (e.g., Wide Area Networks, Local Area Networks, Wireless Networks, Cellular Networks, satellite-based networks, etc).

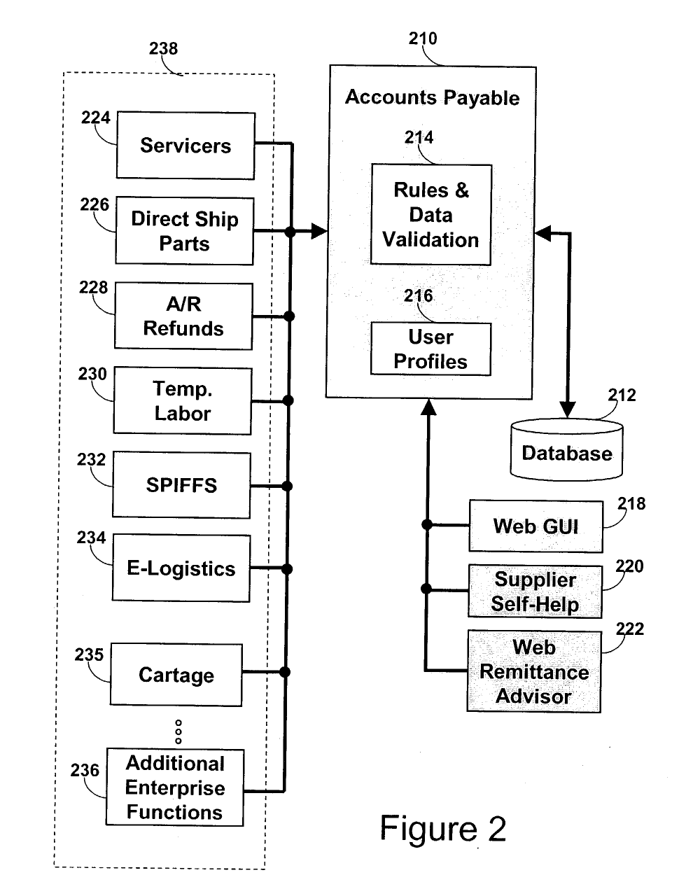

FIG. 2 provides a functional block diagram of exemplary processing software modules of the SupplierNet system 116. An accounts payable module 210 is comprised of validation data and rule-based logic 214, which enables intelligent automation and streamlining the enterprise's accounts payable functions. These rules and data validation checks 214 comprise system intelligence checks such as terms and conditions negotiated with suppliers, compliance data checks, enterprise settlement terms and checks, accounts payable procedural checks (e.g., authorization, encoded schema, etc.), etc. Upon the accounts payable module 210 receiving a file, the received file is checked for accuracy and/or errors. For example, a file is checked to determine if a duplicate file exists, a partially duplicated file exists, data supplied is incomplete, and/or if any erroneous data is present. Erroneous files are not accepted into the accounts payable system and are returned to the originator (e.g., supplier) for corrective action. Prior to returning erroneous files to the originator, data files are edited supplying an indication of the error type encountered yielding an intelligent validation solution for error detection.

This exemplary implementation utilizes a graphical user interface (GUI) that supports communication and access to the SupplierNet system along with the accounts payable rule-based intelligence 214 and an associated online database 212. This logic utilizes database 212 that is accessible to users per a user profile module 216. The user profile module may be comprised of settings per user account that determine explicit access privileges the individual user account possesses upon gaining access (i.e., logging into) to the SupplierNet system. For example, an external supplier will be granted access to relevant data for processing their transactions with the enterprise but not another supplier's data. The on-line database 212 is used to store data such as the Purchase Order (PO) number, service provider information, total costs authorized, authorization data, pertinent dates, description data of goods and/or services, quantities, and associated terms and conditions, and other payment information.

This exemplary embodiment of the accounts payable electronic processing system is also comprised of a Web GUI 218, a Supplier Self-help module 220, and a Web Remittance Advisor 222. The Web GUI 218 acts as the conduit to the accounts payable electronic processing system and functions as a Web site managed by the enterprise. The Supplier Self-Help module 220 acts as an aid to the user. The Supplier Self-Help module 220 accommodates the supplier (i.e., user) in obtaining data accessible to them based on their user profile; advises/guides them in order to resolve issues and/or questions regarding transactions with the enterprise; informs them of incomplete invoices; aids them in e-invoice generation; offers system definitions and potential issue resolution advise, etc. For example, if a supplier needs to determine how to successfully generate an e-invoice, the Supplier Self-Help module 220 provides an interactive, step-by-step guide along with system definitions and answers to frequently asked questions on-line. This solution also permits the supplier to obtain the information as needed since it is on-line—data is available when needed. Flexible queries of on-line data can be made 24/7 by PO, date, invoice number etc. This system also supports communication with the enterprise via email. The following elements may comprise of on-line support for the supplier:

Accounts payable disbursements and PO hot links to access associated data

Account Queries

Supplier Information

Answers to Frequently Asked Questions

Tutorial

The Web Remittance Advisor 222 offers support to the supplier by providing the capability of letting the supplier download data in compatible data formats enabling automation within their accounts payable system (e.g., Excel file type, flat file type, etc.) yielding cost savings (i.e., automated reconciliation vs. manual reconciliation). Remittance advices are posted to the SupplierNet web site instead of mailing the paper remittance advice. This is believed to offer the substantial reduction in cost when compared to EDI solutions especially for high volume download capabilities.

The accounts payable 210 module interfaces with a plurality of function specific input software modules 238 that represent either a service and/or a product that is supplied by a service provider to the enterprise that has to be processed by the accounts payable system in order to generate payment for settlement of the transaction with that particular supplier. These modules collectively support various aspects of the enterprise's operations as they relate to all types of business transactions and the automation thereof. Functional division into a plurality of accounts payable input software modules 238 enables seamless centralized processing support for the entire enterprise. This approach to the disclosed invention enables all the complexities encountered for “total buy” by an enterprise to be accommodated. Each software module 238 that interfaces with the accounts payable module 210 possesses special processing unique for the particular function and/or cost type being supported. In this exemplary embodiment, input modules are comprised but not limited to the following types:

Servicers (i.e., Suppliers, Vendors) 224

Direct Ship Parts 226

Accounts Receivable (A/R) Refunds 228

Temporary Labor 230

SPIFFS 232

E-Logistics 234

Cartage 235

Other Enterprise Functions 236

Other Enterprise Functions 236 is a representation for additional enterprise functions/capabilities based on the needs of any given enterprise application. For example, an additional capability may be the enterprise's bank reconciliation support module. Data would flow from the accounts payable 210 module in this instance, into the enterprise's bank reconciliation support module. The enterprise would send the financial institution electronic information regarding (i.e., bank) required payments. Then, the bank may send the enterprise a file containing settlement data (e.g., a settlement check from a supplier was cashed on a specified date), which is recorded in the accounts payable system database. This information becomes very useful for example, upon a disgruntled service provider claiming receipt of payment was unfilled; the record can be queried from the electronic accounts payable system and presented to the service supplier. Electronic access to the settlement data (e.g., check number issued to settle the account) and the date of settlement (e.g., the date a check was cashed) yield a very effective, streamlined resolution.

SPIFF represents a sales incentive payment program wherein a sales person earns additional money for selling the enterprise's product(s) to a consumer. As an expository embodiment, a sales person sells an enterprise's refrigerator product to a consumer. This sales person is rewarded an incentive of $10 for every unit they sell. The service provider enters their identification number along with the product information into a cash registration system upon sale to the consumer. This data is collected and electronically communicated to the enterprise's SPIFF module. The SPIFF module communicates approved data to the accounts payable module 210 for validation, verification and settlement.

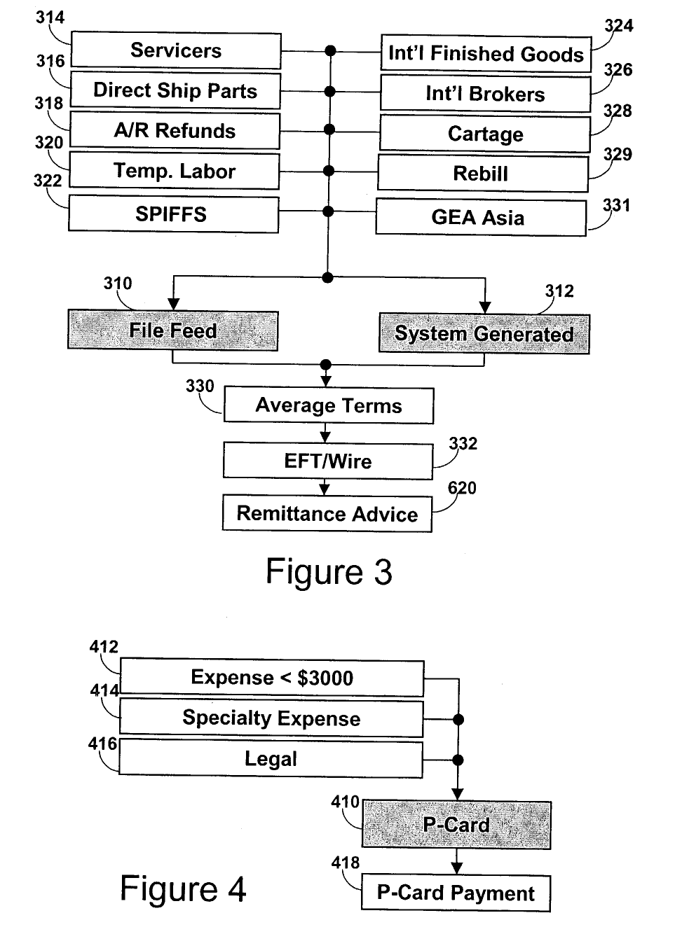

FIGS. 3-6 illustrate exemplary accounts payable inputs for expenses, material costs, and freight costs that are associated to their perspective accounts payable decision logic for a plurality of settlement types. Costs include but are not limited to, expense sources such as Servicers 314, Direct Ship Parts 316, Accounts Receivable (A/R) Refunds 318, Temporary Labor 320 (i.e., e-time), SPIFFS 322; Material and freight sources such as those originating from International Finished Goods 324, International Brokers 326, Cartage 328 (e.g., shipping charges), Rebilling 329, and International Operations 331, such as GEA Asia. These costs are inputted into the accounts payable module 210, which is accomplished either via a file feed 310 or a system generation 312. Settlement date for either file feed or system generated costs may be determined with a module designated “Average Terms” 330 established by the enterprise relative to the type of cost(s) incurred and settled via EFT or wire transfers, as shown in block 332. For example, an enterprise may establish Average Terms that settle (i.e., pay a bill) an account number as follows:

By way of example, average 75 day terms may mean that costs dated from the 4^{th} of one month to the 3^{rd} of the next month settle on the 3 of the second next month. Thus, invoices received, for example, from January 4^{th} through February 3^{rd} would settle on April 3^{rd}. In one exemplary embodiment, expenses less than $3000, such as shown at block 412, Specialty Expenses 414, and Legal Expenses 416 are inputted into the accounts payable system as P-Card 410 cost types. The P-Card possesses similar functions of a charge card, simplifies purchases and settlement. An advantage of the P-Card is that the bank pays vendors directly for purchases within a few days and the enterprise settles the account with a single monthly electronic P-Card payment 418 for all expenses incurred during that period.

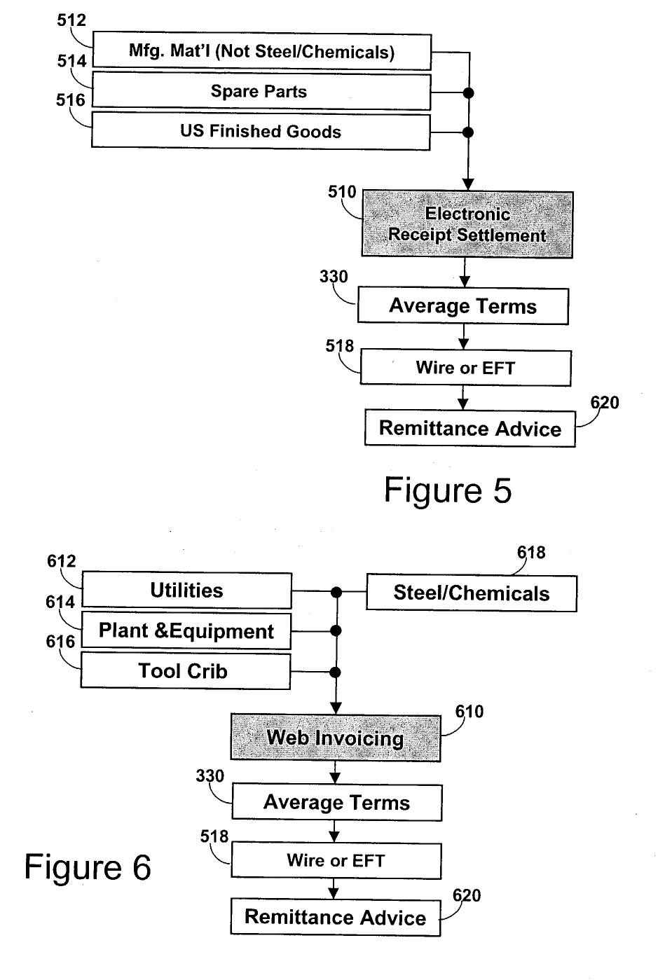

As shown in FIG. 5, Manufacturing Material (e.g., materials other than steel/chemicals) 512, Spare Parts 514, and US Finished Goods 516 are inputted into the accounts payable system via Electronic Receipt Settlement 510 where settlement date may be determined by Average Terms module 330. By way of example, the settlement method may be EFT or Wire 518 with the settlement details being accessible to the supplier via the Remittance Advice 620.

As shown in FIG. 6, Utility 612 bills, Plant & Equipment 614 (P&E), and Tool Crib 616 costs along with Steel/Chemical 618 material costs are inputted into the accounts payable system via electronic Web Invoicing 610 (i.e., e-invoice). Web Invoicing refers to a portal on the GEA SupplierNet system that allows suppliers to electronically invoice a business (e.g., GEA) for expense PO related items by selecting their Purchase Order, completing the appropriate invoice information and submitting the invoice. Once the invoice is submitted, the invoice may be stored in an imaging database, then the supplier is given a confirmation number upon successful storage of the invoice's image. Settlement date is determined from Average Terms module 330 and settlement may be made via wire or EFT, as shown at block 518. Settlement details are available to the supplier by way of the Remittance Advice 620. Data advising the supplier of the status of an e-invoice along with other pertinent information may be presented to the supplier by accessing the SupplierNet system to obtain their electronic invoice summary.

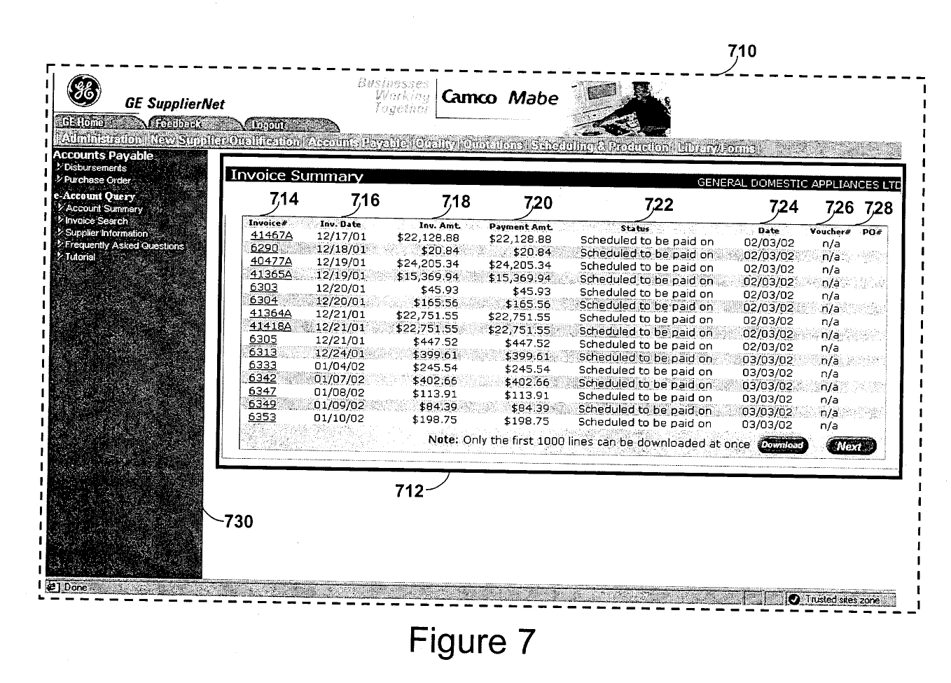

FIG. 7 depicts an exemplary SupplierNet Web page 710 that serves as presentment of information regarding an electronic invoice summary 712 to the user. Respective hyperlinks for linking users of the system of FIG. 1 over a communications network may be embedded in this Web page where links are comprised of elements such as presentment of disbursements and purchase orders. Additional hyperlinks are comprised of presentment of the particular account information such as account query functions 730. Exemplary data fields shown in this depiction of the Web page are comprised of the following:

Invoice Number 714

Invoice Date 716

Invoice Amount 718

Payment Amount 720

Status of Invoice 722

Date of Action 724 (e.g., if Status of Invoice 722 is “to be paid on” then the “date of action” field provides the specified date)

Voucher Number 726

Purchase Order (PO) Number 728

These data fields may also be hyperlinks that provide further associated detail on subsequent Web pages of the accounts payable system. For example, the Invoice Number 714 field is a hyperlink that the user can activate to initiate presentment of details associated with the particular invoice of interest. Data supporting the Web presentment is stored in the on-line database 212.

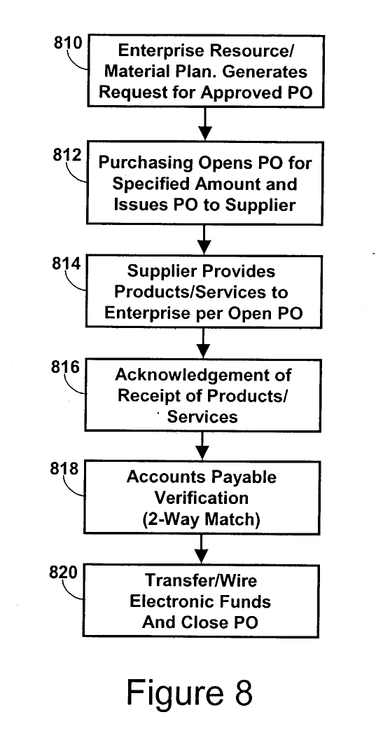

An exemplary processing flow diagram for domestic transactions is represented in FIG. 8 wherein a transaction is initiated at block 810 upon the enterprise Resource and Material Planning group generating a request for a PO that has been approved. As shown at block 812, Purchasing ensures the appropriate authorizations have been fulfilled, electronically issues a PO and notifies the designated Supplier. The Supplier accesses their account in the SupplierNet, system for presentment of the authorized PO information. The SupplierNet system stores this data in its on-line database 212 (FIG. 2) along with a PO status of “open”. At block 814, the Supplier then provides ordered products and/or services to the enterprise per the open PO terms and conditions. For example, consider an enterprise that has an internal Parts Division, such as the assignee of the present invention. At block 816, the Direct Ship Parts 226 module supports acknowledgement of fulfillment that the ordered parts were shipped. This confirmation in essence becomes the Parts Division's invoice. Therefore, upon a Supplier sending manufacturing goods to the enterprise's factories; the acknowledgement of receipt of those goods triggers an accounts payable settlement. The accounts payable 210 module verifies that the receipt of goods acknowledgement matches the associated PO data. At block 818, this is considered a “2-way match.” No invoice is required yielding a streamlined, totally electronic solution. Conversely, upon an open PO being fulfilled; the Supplier may access their SupplierNet account; locate the PO record that has been fulfilled; and generate an e-invoice for presentment to the enterprise. The accounts payable 210 module verifies that the e-invoice data matches the PO data also yielding a “2-way match” 818. In this case, no receipt is needed. The “2-way match” is the Accounts Payable process of either matching data from a receipt of goods acknowledgement or matching data from an e-invoice, to the associated PO data resulting in initiation of settlement and closure of the PO at block 820.

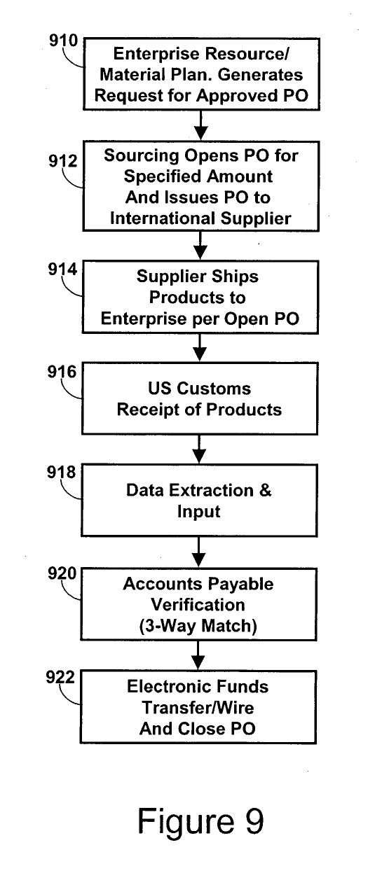

International business transactions require compliance with US Customs rules and regulations and therefore may need additional processing. For example, whatever the International Supplier declares to customs should be the amount the enterprise pays or detailed reconciliation will be required to resolve discrepancies. An exemplary processing flow diagram for international transactions is represented in FIG. 9, wherein a transaction is initiated upon the enterprise Resource and Material Planning group generating a request for a PO that has been approved 910. Sourcing ensures the appropriate authorizations have been fulfilled and electronically issues a PO and notifies the designated International Supplier at block 912. The accounts payable electronic system 116 stores this data in the on-line database 212 along with a PO status of “open”. The International Supplier then ships the ordered products to the enterprise per the open PO terms and conditions at block 914. This international shipment is received by US Customs at block 916 along with detailed electronic documentation delineating information such as the Master Shipper number (i.e., a unique number assigned to each shipment), containers shipped, boat used, dates, part numbers, quantities of items, PO number, pricing data, etc. Pertinent data is extracted from this electronic documentation and inputted at block 918 into the electronic accounts payable system 116 as the International Supplier e-invoice. Upon the open PO being fulfilled, the accounts payable 210 module verifies that the PO data, receipt of goods acknowledgement data from US Customs, and e-invoice data, all match yielding a “3-way match” at block 920. The “3-way match” results in initiation of settlement of the PO at block 922.

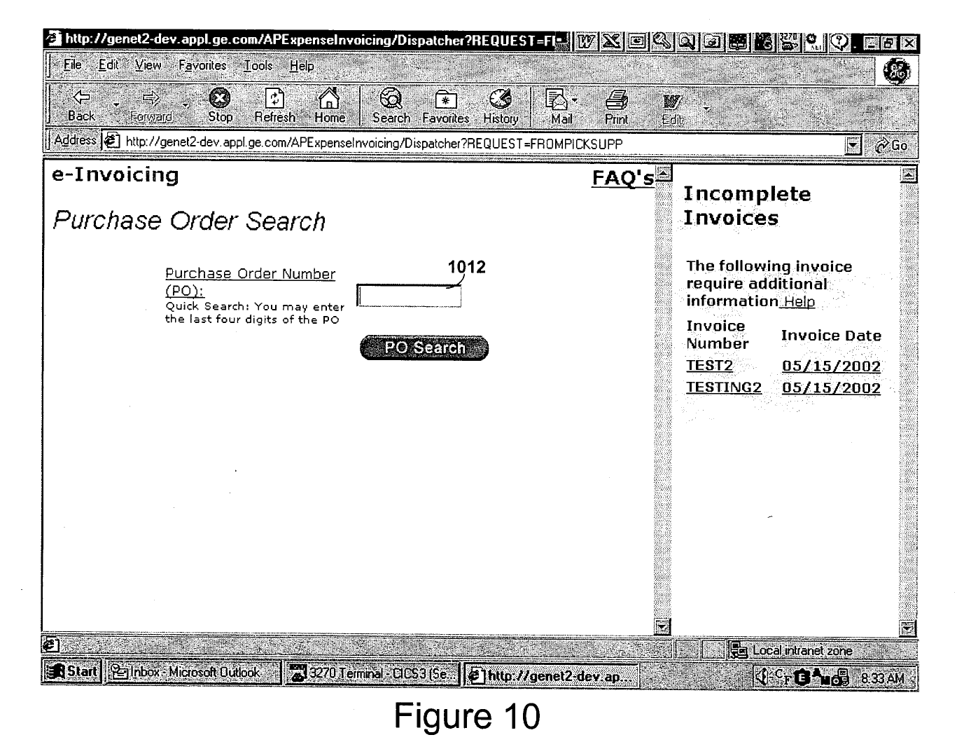

FIG. 10 illustrates an exemplary Web page for searching a PO Number. In one exemplary embodiment, a date entry field 1012 is used to enter the PO Number to be searched.

E-Invoice

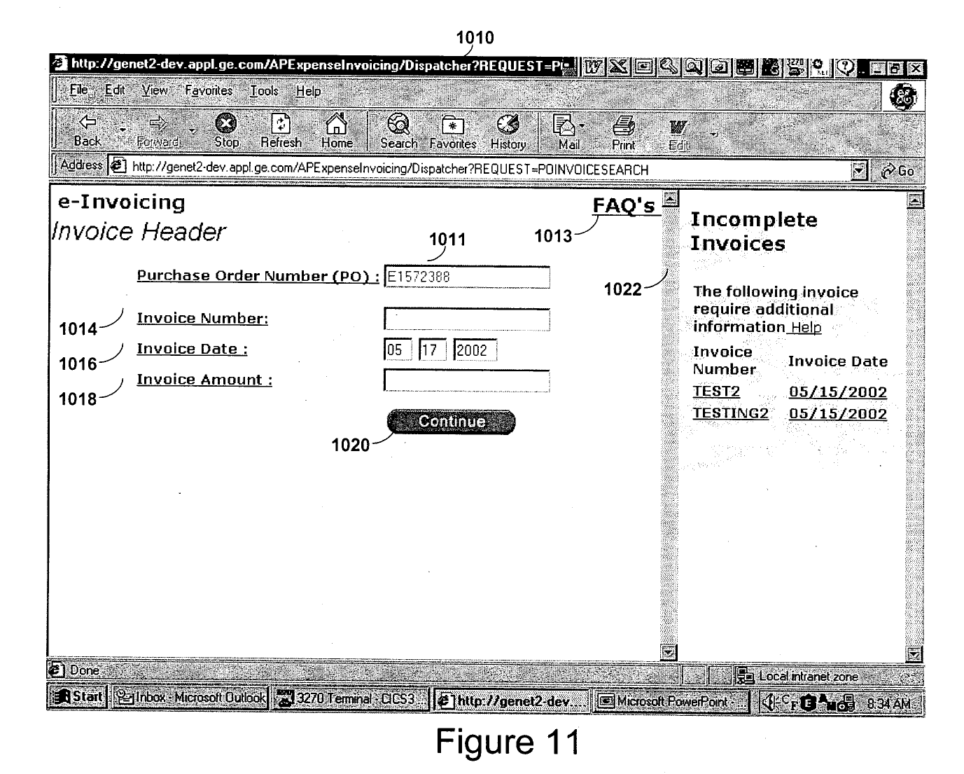

FIG. 11 illustrates an exemplary accounts payable system Web page 1010 supporting the generation of an e-invoice including respective hyperlinks for linking users of the system of FIG. 1 over a communications network. In this embodiment, the Web page is comprised of the following data types to be utilized in the generation of an e-invoice:

PO Number display 1011

Invoice Number 1014, such as may be used for continuance and/or completion of generation of an e-invoice or to correct an existing e-invoice

Invoice Date 1016

Invoice Amount 1018

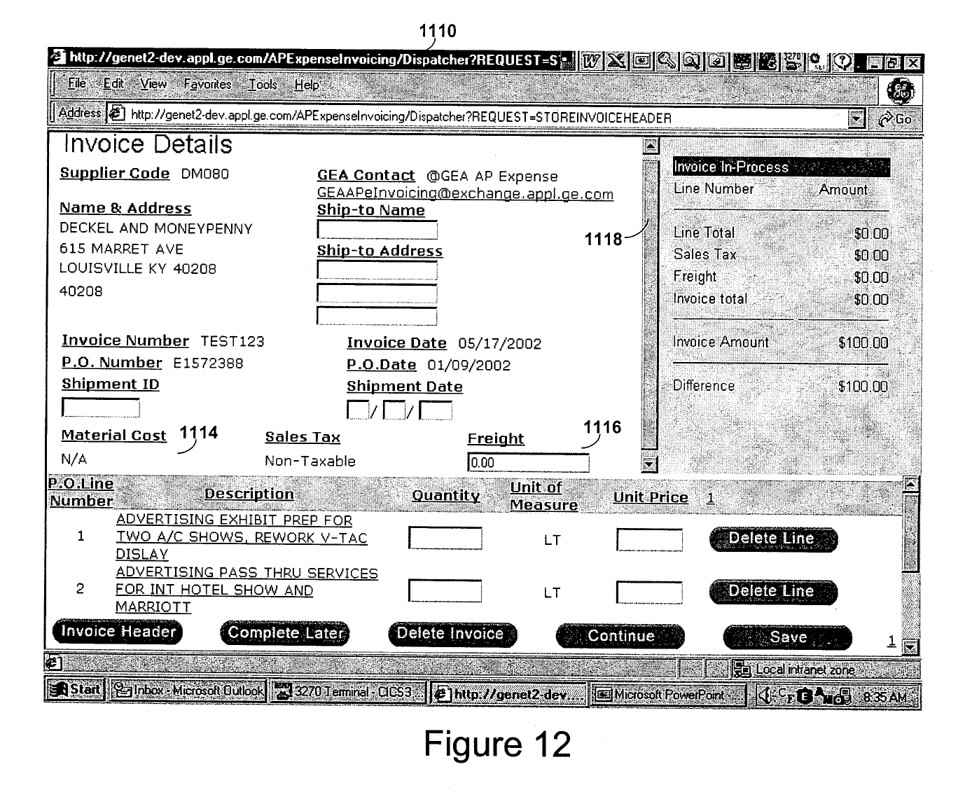

Another window with fields regarding incomplete invoices 1022 is provided to the user as well. These consist of additional hyperlinks that yield presentment of a subsequent Web page with pertinent data associated to the hyperlink selected. The Supplier Self-Help 220 module offers assistance to the user relating to the current topic such as a FAQs link 1013 in this instance. On-line help assists the user in providing answers to issues typically encountered. Data fields in this Web page can also be hyperlinks that further provide associated detail on subsequent Web pages of the accounts payable system. Upon the user providing the necessary data and digitally pressing a “Continue” button 1020, as shown in FIG. 12, a subsequent e-invoice generation Web page 1110 is presented. Web page 1110 presents data to the user in the form of hyperlinks, uneditable data fields number 1114, and editable data fields 1116. Data fields associated to edit boxes 1116 permit the user to enter data into the SupplierNet system. Data fields are associated to actual account contractual obligations. Data fields without edit boxes are not applicable since such fields may be preset in response to the applicable purchase terms and will not accept inputs from the user. The purchase term data may be retrieved from the on-line database. These limitations mitigate erroneous data inputs and labor intense rework. As an element in the Supplier Self-Help 220, an “Invoice In-Process” window 1118 is provided with data and hyperlinks to aid the user in successful creation of the e-invoice.

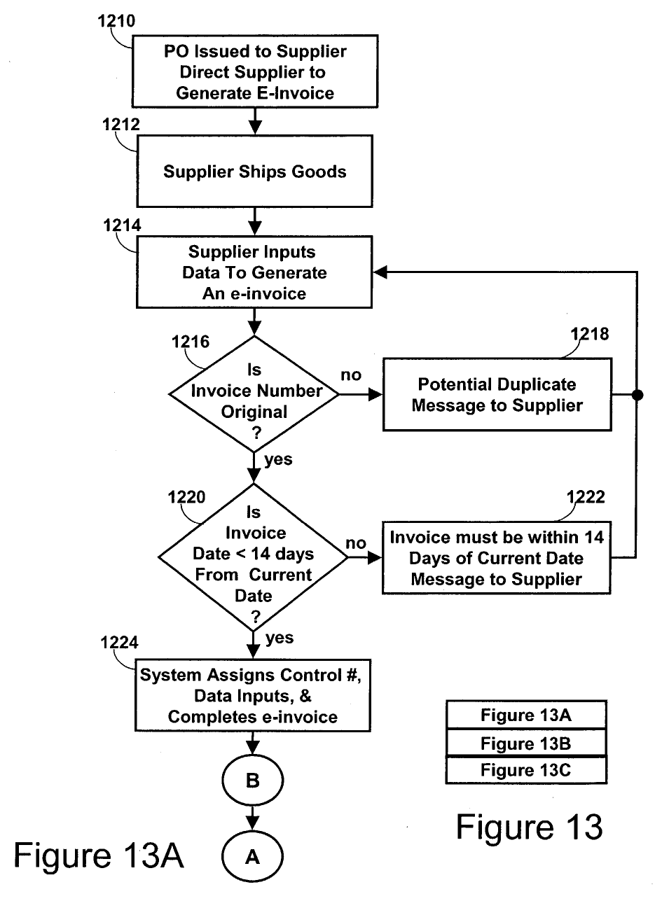

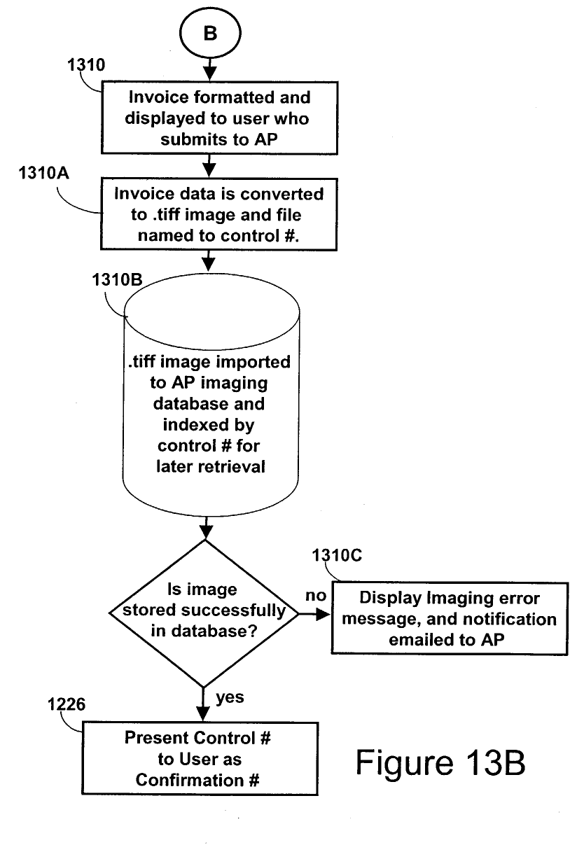

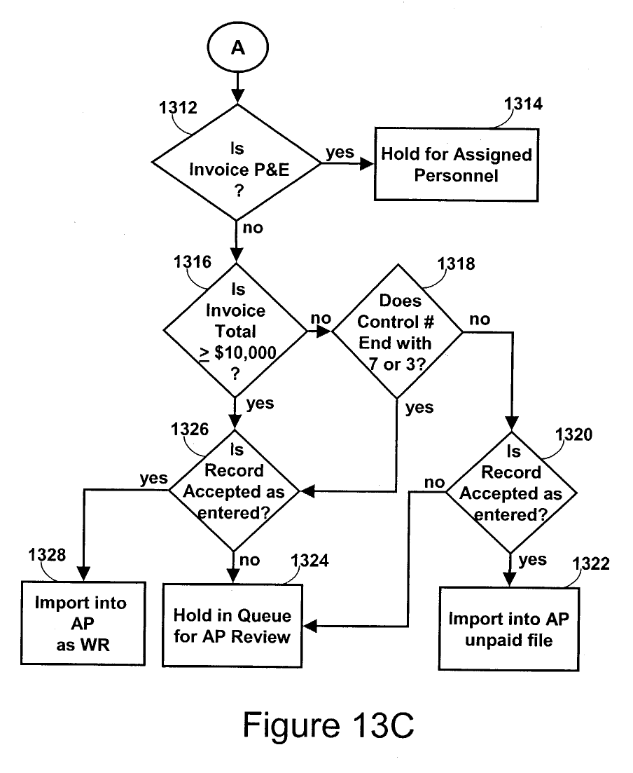

FIG. 13, collectively made up of FIGS. 13A through 13C detail an exemplary embodiment of an accounts payable e-invoice generation processing flow that begins with a PO being electronically issued to a Supplier, for directing the Supplier to generate an e-invoice at block 1210. The Supplier ships goods according to the PO at block 1212 and then logs into the SupplierNet system to generate the e-invoice at block 1214. The Supplier navigates to the Web pages depicted in FIGS. 10-12. A check is performed to determine if the invoice number inputted by the user is original at block 1216. If the invoice number is not an original number, a message is presented to the user alerting them of potential duplicate invoice creation at block 1218 and the user addresses the issue supplying an original invoice number for continuance. In one exemplary embodiment, upon the invoice number being original, a check is performed to determine if the invoice date is less than fourteen days from the current date at block 1220. If this is not true, a message is presented to the user informing them that the invoice date must be within fourteen days of the current date 1222. Upon an acceptable invoice date inputted into the system, the system assigns a control number to the invoice and the user supplies further input detail to complete the e-invoice at block 1224. Invoice data is then imported into an invoice template for presentment at block 1310. Upon the user submitting the invoice, data indicative of the invoice is converted to an image file (e.g., a .tiff image file) identified by the control number, as shown in block 1310A. The image file is then imported to the AP imaging database and indexed by the control number for later retrieval, as shown in block 1310B. The system then verifies the index has successfully imported to the imaging database. If the import is not successful, an imaging error message is displayed to the user and the user would attempt to resubmit, as shown in block 1310C. If the import is successful, the system displays the control number to the user as a confirmation number, as shown in block 1226.

Processing continues for disposition of the e-invoice. A check is made to determine the type of transaction, e.g., whether the e-invoice is associated to a cost incurred for P&E at block 1312. The invoice is then held for the assigned personnel at block 1314. In one exemplary embodiment, if this is not a cost incurred for P&E, another check is performed at block 1316 to determine the amount of the invoice, e.g., whether the total invoice amount is greater than or equal to $10,000. If the total invoice amount is greater than or equal to $10,000, then a check is performed at block 1326 to determine if the e-invoice record is acceptable (i.e., correct) as entered. Upon the e-invoice data being acceptable, the e-invoice data is imported into the accounts payable 210 module with the status of “awaiting receiver processing” at block 1320. If the record is not acceptable as entered, it is held in a queue for the accounts payable personnel to address at block 1324. For the case where the invoice total is less than $10,000, a check is performed at block 1318 for an encoded scheme associated with the control number assignment (e.g., the ending digit of the assigned control number). Upon checking at block 1318 and verifying the e-invoice data is acceptable as entered in block 1326, the e-invoice data is imported into the accounts payable 210 module with the status of “awaiting receiver processing” at block 1328. If the record is not acceptable as entered, it is held in a queue for the accounts payable personnel to address at block 1324. If the encoding scheme check does not possess the specified number(s) at block 1318, the record is checked for acceptability at block 1320. If acceptable, it is imported into the accounts payable 210 system as an “unpaid file” at block 1322.

Temporary Labor

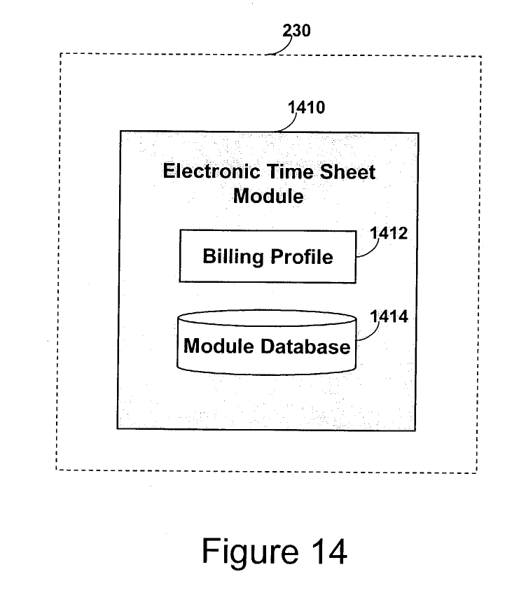

An exemplary embodiment of the accounts payable system as it relates to the Temporary Labor functions is comprised of managing payment of services based on the billable time of a service provider 114 who performs the services. As shown in FIG. 14, the Temporary Labor 230 Module is comprised of an electronic time sheet 1410 module configured to store a respective billing profile 1412 for each service provider 114 in local memory 1414 (i.e. database, local data storage). A database 1414 is shown as part of an electronic time sheet 1410 module. It will be appreciated, however, that this database 1414 could be separate from electronic time sheet 1410 module (e.g., this data could be stored in the accounts payable 210 on-line database 212). The billing profile includes a respective identifier, such as a social security number or other unique user number assigned by the contracting organization, or both, for uniquely associating each respective billing profile to each service provider. The billing profile may further include one or more account numbers for identifying one or more projects for which that service provider has been authorized to render services. Database 1414 may further include information indicative of at least a first manager 126 or any appropriate individual responsible for managing billing information of the service provider based on account number information. As used herein, the term account number may broadly encompass a project account number or any other suitable identifier for associating the billable time to a particular account, project or any other designation. It should also be appreciated that this embodiment depicts an external service providers processing; and an internal service provider could replicate a similar scheme, leveraging an Intranet 120 and internal terminals 122 for communications.

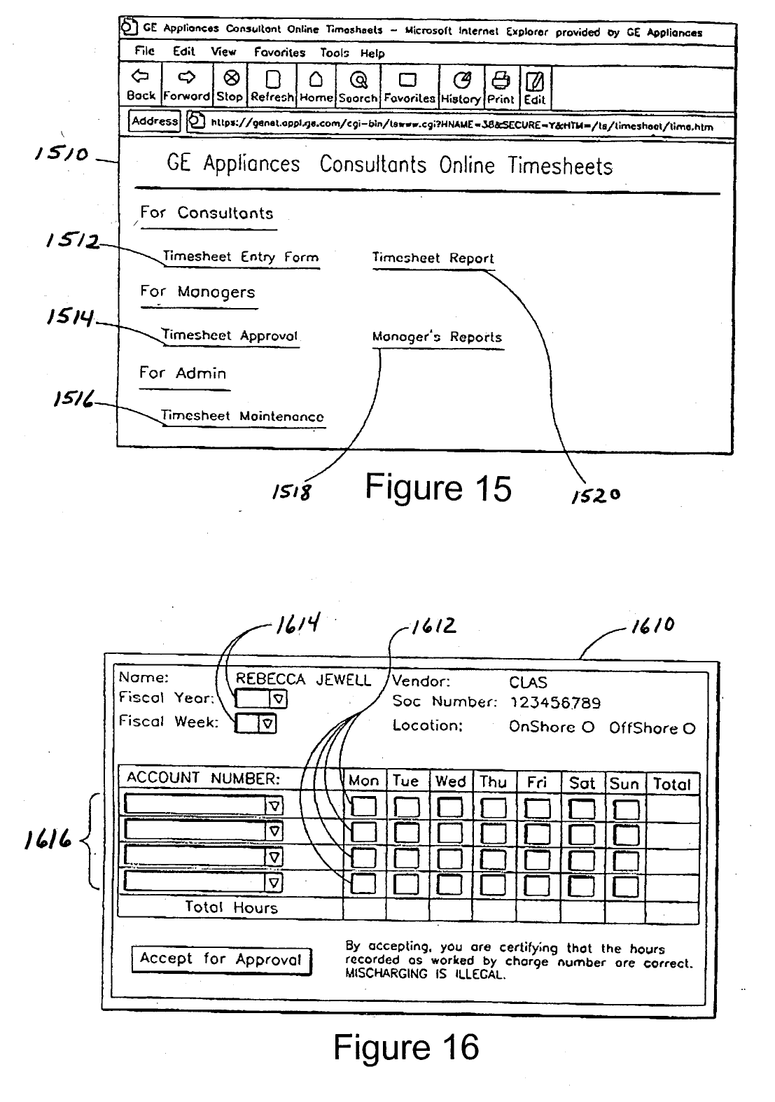

The electronic time sheet module 1410 is configured to provide a Web page 1510 (FIG. 15) including a link, e.g., hyperlink 1512, for linking over a communications network 112 the service provider to an electronic time sheet 1610 (FIG. :16) using a Web-enabled terminal 110 loaded with any suitable commercially available browser, such as Microsoft Explorer, and e-mail application, such as Outlook Express application. Web page 1510 includes a link 1520 that may be used by the service provider for monitoring the status of a submitted time sheet. The appropriate manager may use a link 1514 to access a submitted time sheet for review and approval. Such manager may use a link 1518 to access reports generally available to management personnel. A link 1516 may be available to the system administrator for performing routine maintenance of the system. It will be understood that any of the foregoing users will only be allowed access to the system upon having complied with appropriate login procedures, such as user identification, and password.

As shown in FIG. 16, the electronic time sheet includes a plurality of data fields 1612 for entering billable time for an identified period of time. The service provider respectively fills data fields 1614 used to identify the year and week associated with the entered billable time. The service provider may use a drop down menu 1616 to select the appropriate account number for any entered billable time. Upon completion and submittal of the electronic time sheet by the service provider, the electronic time module provides each electronic time sheet over the communications network 112 to each first manager to indicate in a respective data field of the time sheet whether or not each first manager approves the billing information of that service provider corresponding to a respective account number for the identified period of time.

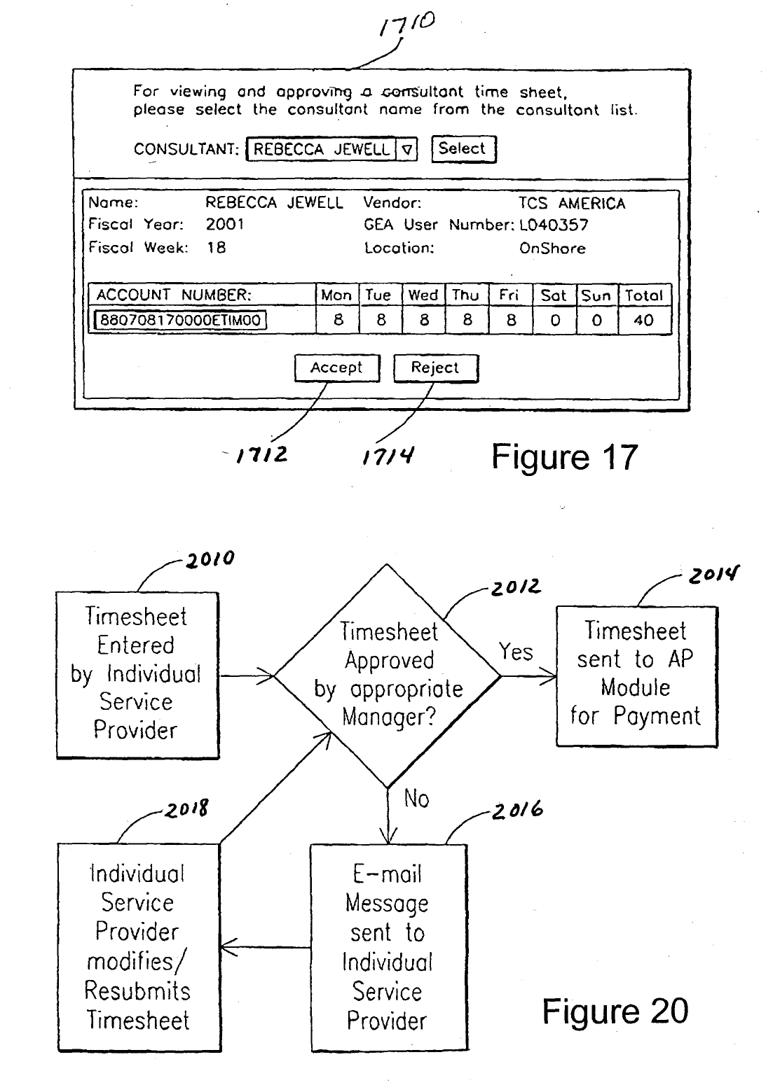

FIG. 17 illustrates an exemplary time sheet 1710 submitted by Ms. Rebecca Jewell for approval of billable time corresponding to account number 880708170000TIM00 for fiscal week 18. In this case, the approving manager could perform a computer mouse click on an icon 1712 labeled Accept or could perform a mouse click on an icon 1714 labeled Reject. If the manager rejects the submitted time sheet, a data field would be provided for entering comments regarding the basis of the rejection. In general, different account numbers may, but need not, have different approving managers.

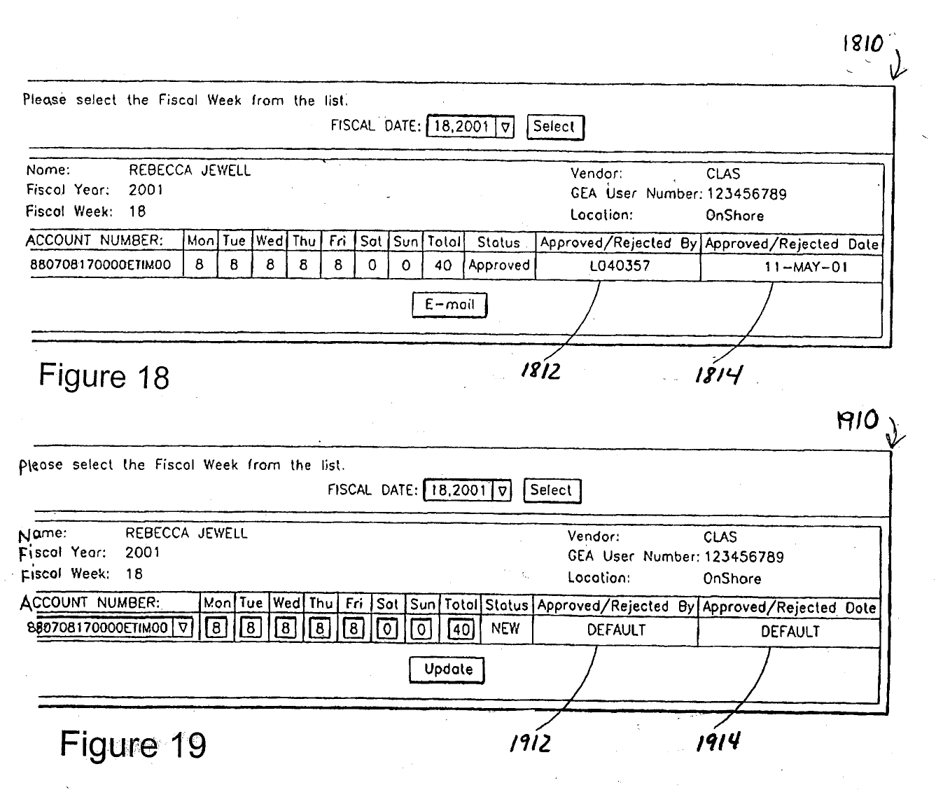

FIG. 18 illustrates a time sheet 1810 upon having been approved by a manager identified by a suitable identifier, e.g., L040357, in data field 1816 and the date of the approval in data field 1818. It will be appreciated that there may be instances when the first manager may be unavailable due to any of a variety of reasons. To avoid unnecessary delays, the manager information stored in database 1414 (FIG. 14) will include information for a second manager responsible for managing the electronic time sheet of service providers booked to specific accounts in the event the first manager is unavailable. In one exemplary embodiment, the system will notify both managers at the same time that there are time sheets that need approval. Only approval from one of the managers is required to approve the time sheet. In another embodiment, the first manager may notify via e-mail the electronic time sheet 1410 module (FIG. 14) of a period of time where that first manager will be unavailable. Once that notification has been received, the electronic time sheet module would send an E-mail message to the second manager including a suitable link to any time sheets that may require review and approval by the second manager. Thus, it will be appreciated that the logistics for informing the first and second managers may be implemented in a variety of ways depending on any desired implementation.

FIG. 19 illustrates a time sheet 1910 that has not yet been approved by the appropriate manager. The system is configured to include the words DEFAULT or any other suitable indicator in data fields 1912 and/or 1914 to indicate that such time sheet requires appropriate approval.

FIG. 20 illustrates an exemplary flow chart regarding the approval process for an electronic time sheet. Block 2010 represents the action of entering billable time by the individual service provider. Block 2012 represents a decision action of whether or not the appropriate manager approves the time sheet provided by the service provider. As shown at block 2014, if the appropriate manager approves the submitted time sheet, then that time sheet is submitted to an accounts payable module 210 (FIG. 2) for payment. In one of the many advantageous features of the present invention, it will be appreciated that the present invention provides data interfaces from the electronic time sheet module that can be adapted and usable by virtually any commercially available accounts payable systems. If the manager disapproves the submitted time sheet, as shown at block 2016, an e-mail message would be sent to the individual service provider for corrective action. As shown at block 2018, upon the individual service provider having taken appropriate corrective action, then the individual service provider would resubmit the time sheet for approval to the appropriate manager.

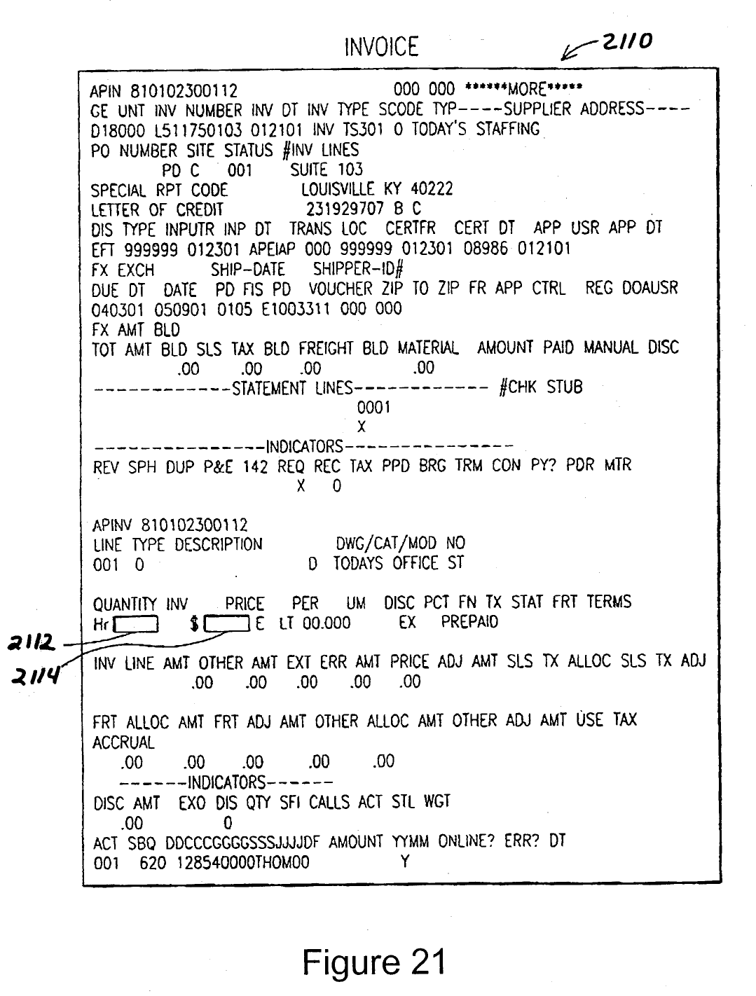

FIG. 21 illustrates an exemplary invoice 2110 with a suitable invoice number, e.g., invoice number L511750103 would indicate the billings for Fiscal Week 3 of the year 2001 for service provider L511750. Invoice 2110 includes a data field 2112 for the billable time entered by the service provider. Another data field 2114 may be filled with the billing rate of the service provider, as may be retrieved from the billing profile in database 1414 for that service provider. As suggested above, the billing profile may further include an overtime rate, discount rate, etc., and other parameters that may be needed for computing the actual amount to be paid to the agency for services provided by the service provider. As further suggested above, the rule base may include a due date for triggering payment to the agency. In one exemplary embodiment, the payment may comprise an electronic fund transfer made to a payee account number designated by the employment agency. As suggested above, another advantageous feature of the present invention is for the payment information to be presented to the service provider's agency in a manner easily recognized by the agency. For example, each payment includes a Web page along with an appropriate level of remittance information accessible by personnel 126 of the employment agency via the communications network 112, 120. As will be readily understood by those skilled in the art, the remittance information may include information, such as the service provider's unique identifying number, the calendar year, the fiscal week during which services were provided and approved, project account number, etc. Thus, it will be appreciated that the paperless system of the present invention systematically and accurately yet inexpensively integrates both the time keeping aspects, the invoicing aspects, and the payment and remittance aspects to the outside agencies with minimal human intervention in a way that can be readily used by a large number of service providers regardless of the location of the system users.

As delineated in FIGS. 2-3, the accounts payable module 210 is responsive to data file feeds from the Temporary Labor 230 Module of approved electronic time sheets. In one exemplary embodiment, the data file feeds may be performed on weekly basis. It will be understood, however, that the frequency of data file feeds to the accounts payable module 210 may be varied depending on the specific application. Accounts payable module 210 includes a rule base 214 with rules or terms prescribing the payment of services; as such terms may have been negotiated with respective personnel 126 of the employment agency. The accounts payable module further includes a processor configured to process each approved electronic time sheet using the billing profile of the service provider to generate an electronic invoice and issue payment thereof in compliance with the rules in the rule base for the services performed by that service provider over the identified period of time. For example, in one exemplary embodiment, any time sheet submitted sixty days after the rendering of services would not be accepted for payment. It is believed that this feature would encourage the timekeepers to have a more proactive behavior regarding entry of billable time.

E-Logistics

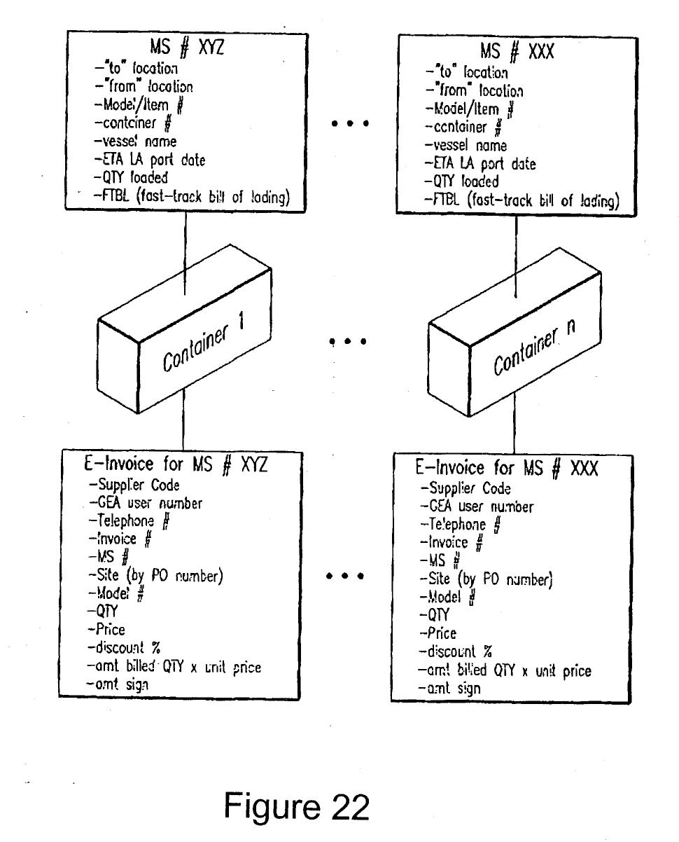

Prior techniques do not have a means to reconcile discrepancies of inbound shipments received relative to the invoice for that product. For example, a first invoice may claim that 50 SKUs were supplied in a given container. A second invoice may claim that 40 SKUs were supplied in another container. However, prior to the present invention, the accounting team did not have any reliable and accurate way of uniquely correlating each container to a specific invoice. Thus, if the first container actually carried 44 SKUs and the second container actually carried 46 SKUs, the accounting team would be hard pressed to determine which shipment corresponds to a respective invoice. Another aspect of the present invention, allows associating or relating each unique MS number assigned to every container with the individual invoice records and shipment information for that container. This permits automatically matching of every receiver to a shipment. FIG. 22 is a schematic that conceptually illustrates this as well as the correlation of the MS number to an e-invoice. As suggested above, the MS number allows tracking each container as that container moves along the distribution chain. Providing a common identifier that uniquely associates physical shipment and accounting for each container has proven to synergistically simplify both the accounting and the container tracking operations. For example, such technique allows users to develop more complete and realistic information of the physical, chronological and financial aspects associated for each shipment of goods. This information may be accumulated to develop historical data that may be used to determine trends in the distribution chain over known periods of time. For example, one may be able to determine incremental delays in the shipment process due to increased security checks at the port of destination.

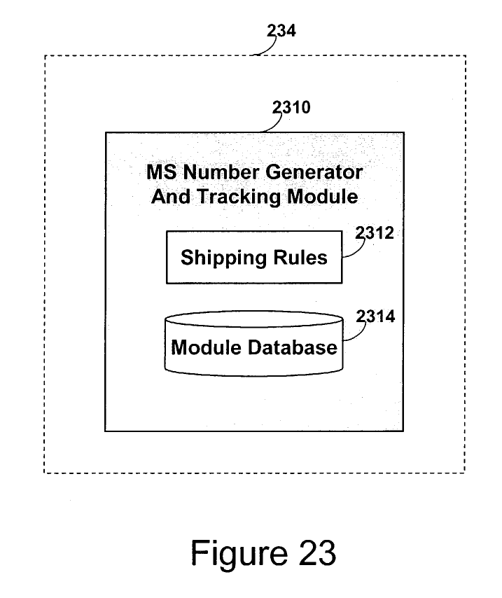

Consider an exemplary embodiment of the accounts payable system as it relates to the e-logistics functions leveraging the MS number. As shown in FIG. 23, the e-logistics 230 (FIG. 2) module is comprised of a MS number generator and tracking 2310 module configured to store a respective shipping rules 2312 and data in local memory 2314 (i.e. database, local data storage) where a MS number is an identifier used internally in the enterprise to track shipments (i.e., containers) of goods, to move stock from one location to another location within the distribution chain, and to match e-invoices. Techniques of the present invention allow gathering information from the supplier file feed and processing the information in the MS number generator to automatically generate the MS number. The MS number permits the integration of physical shipment information associated with each container to invoice information for that container. Providing a common identifier that uniquely associates physical shipment and accounting for each container has proven to synergistically simplify both the accounting and the container tracking operations. The database 2314 facilitates the storage of MS numbers and associated data. While a database 2314 is shown as part of an MS number generator and tracking 2310 module, it will be appreciated, that this database 2314 could be separate from the MS number generator and tracking 2310 module (e.g., this data could be stored in the accounts payable 210 on-line database 212). Shipping rules which are comprised of business rules for arranging and communicating information regarding a flow of goods from suppliers abroad along the various stages of a distribution chain.

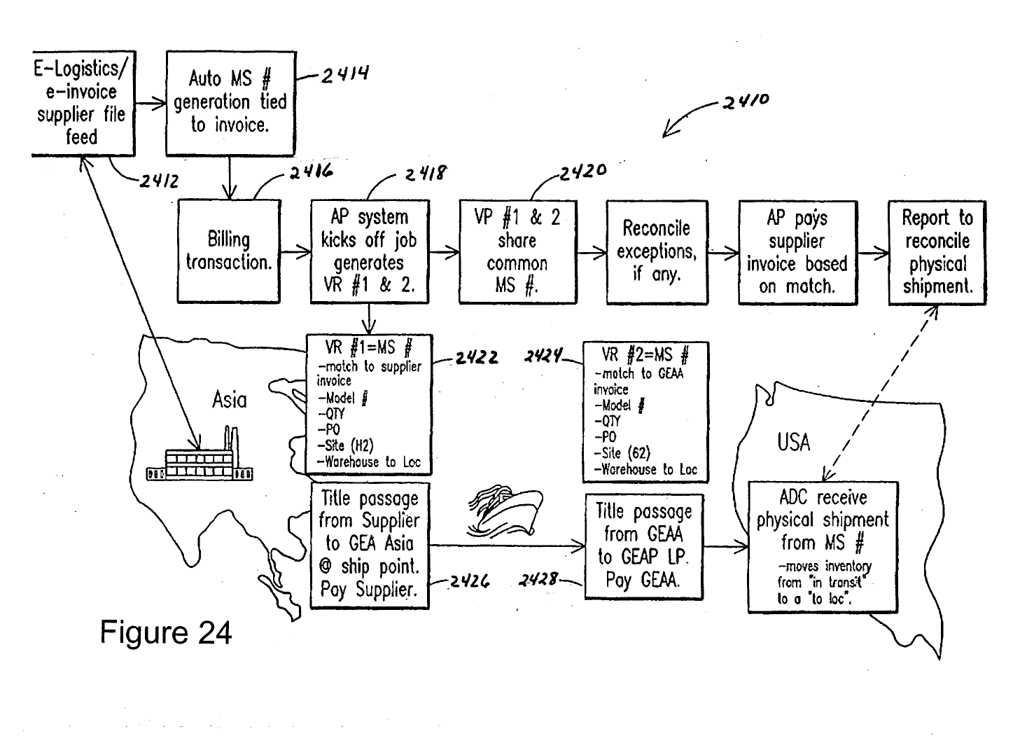

FIG. 24 is an exemplary flow that allows relating multiple receivers involved in the distribution chain to a common MS number 2410. Blocks 2412 and 2414 allow gathering supplier data and generating a respective MS number assigned to a respective container and to the invoice for the goods shipped in the container. Block 2416 allows starting to process a billing transaction. Block 2418 triggers generation of one or more virtual receivers. In the context of an international transaction, for reasons that are juridicially and financially important but immaterial for the purposes of the present invention, one of the receivers may correspond to an entity organized under the jurisdiction of the originating location, e.g., GE Appliances Asia (GEAA). Another of the receivers may correspond to an entity organized under the jurisdiction of the destination location, such as a receiver organized in North America. Briefly, instead of having direct payments from GEA in North America to the suppliers in Asia, GEA transacts with GEAA in Asia, and GEAA in turn transacts with the suppliers of the goods in Asia. As shown at block 2420, each receiver is linked to a common MS number for a given invoicing transaction. As shown at blocks 2422 and 2424, the respective invoices for each receiver being linked to the same MS number. This will advantageously result in a much simplified invoice reconciliation process. As suggested above, block 2426 represent passage of title from the Asian supplier to GEAA, and block 2428 represents passage of title from GEAA to the entity in North America. Some of the benefits of the present invention include: the ability to reconcile the invoices regardless of the number of receivers that may be involved, the ability to reconcile exception, to provide a clear connection of shipment discrepancies, and to improve productivity to accounts payable functions.

Thus, it will be appreciated that the paperless system of the disclosed invention systematically and accurately yet inexpensively integrates all comprehensive aspects of an enterprise's transactions comprising but not limited to: the invoicing aspects; e-logistics, e-time, e-packing slip; and the payment and remittance aspects to both internal and external suppliers (i.e., agencies) of domestic and international. These transactions require minimal human intervention and are integrated in a way that can be readily used by a large number of service providers regardless of the system users location.

A primary aspect of the invention allows for the elimination of a costly and burdensome paper billing process by obtaining billing information via electronic means. Some benefits include, eliminating paper, eliminating the work required to handle paper invoices, improving payment accuracy, improving payment term variations, and eliminating clerical support and input errors. Improvements in accuracy are clearly obtained by application of this automated, intelligent, rule-based invention. Invoices are generated electronically—e-invoicing so verification of costs can be validated automatically.

Another advantageous application of the present invention may comprise an automated process for managing Vendor Direct invoice payments. Vendor direct refers to a process wherein parts which are ordered by customers of a business (e.g., GEA customers) are shipped directly from a GEA vendor to the customer. An example of this process may be as follows:

Customer orders for Direct Ship parts are processed;

The orders are communicated to Supplier for fulfillment;

When the orders are filled and shipped to the customers, Supplier personnel acknowledge fulfillment of the order in Warehouse Management System (WMS);

The Supplier's input should include the Supplier's invoice number, which is relatable to the cost of the parts shipped;

Parts shipped should be equal to parts ordered; and

The Supplier's invoice number will flow from WMS to a material ordering and invoicing system and, in time, to Accounts Payable and back to Supplier on a payment voucher.

Yet another application of the present invention may comprise an automated foreign exchange (FX) process. For example:

The buyer initiates a PO for a foreign currency supplier in USD;

Foreign currency invoices are input into AP using a dedicated FX module;

By downloading currency conversion tables in a suitable database, the AP system is able to convert the value of the invoices in USD;

Any gain or loss from the conversion is booked to an FX Variance Account;

A file feed is uploaded to FX operations of the enterprise, which then purchases the foreign currency needed to pay the supplier and returns the file back to AP; and

Once the file is returned from Corporate, it is used to close out the FX voucher in the AP system.

Another advantageous application of the present invention may comprise an automated process for managing an escheatment process. That is a process for automatically reporting and managing uncashed checks. In one exemplary embodiment, once an uncashed check becomes 6 months old, the system will generate a letter to the payee reminding them to cash the check. If the uncashed check becomes 9 months old, the funds are moved to a dedicated unclaimed property account where the funds corresponding to the uncashed check are held until they reach the applicable term limit to be escheated to the home state of the payee. At 120 days before escheatment to the state, an additional letter is automatically sent to the payee as a final reminder.

The present invention can be embodied in the form of computer-implemented processes and apparatus for practicing those processes. The present invention can also be embodied in the form of computer program code containing computer-readable instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose computer, the computer program code segments configure the computer to create specific logic circuits or processing modules.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A computerized method for managing payment of products and/or services acquired by a purveyor of goods through respective purchase transactions with a plurality of generally independent entities transacting in commerce with the purveyor of goods, the method comprising:
reading a purchase order for a respective entity for a purchase transaction of respective products and/or services from that entity, the purchase order issued to the respective entity over a communications network;
populating a database with rules prescribing the payment or lack thereof for each purchase transaction based on whether the respective products and/or services being purchased actually fulfill purchase terms applicable to each purchase transaction;
configuring a user-interface for each respective entity to supply invoice data over said communications network, the invoice data being arranged in a plurality of data fields; and
presetting at least some of said data fields in response to the respective purchase terms applicable to any given transaction and thereby avoid introducing incorrect invoice data.

2. The computerized method of claim 1 further comprising collecting fulfillment data indicative of whether respective products and/or services being delivered and/or yet to be delivered actually meet the respective purchase terms applicable to each respective purchase transaction.

3. The computerized method of claim 2 further comprising accessing the database with rules prescribing the payment or lack thereof for each purchase transaction in view of the fulfillment data for each respective purchase transaction.

4. The computerized method of claim 3 further comprising relating the supplied invoice data relative to the fulfillment data and to the rules prescribing the payment or lack thereof for each purchase transaction to determine an appropriate action regarding each respective invoice;
in the event the fulfillment data matches the payment rules for that purchase transaction, processing payment to said entity based on the invoice data; and
in the event the fulfillment data indicates deviations from the payment rules for that transaction, issuing a notice to that user to correct said deviations.

5. A computerized method for cohesively managing account payables accrued by a purveyor of goods through a plurality of distinct types of business transactions with a plurality of generally independent entities transacting with the purveyor of goods, the method comprising:
providing a plurality of distinct transaction-processing modules, each configured to process a distinct type of business transaction that may arise in the operations of a purveyor of the goods;
populating a database with rules prescribing the payment or lack thereof for each distinct type of business transaction based on whether transaction-fulfillment terms applicable to each distinct transaction are met;
configuring a user-interface for each respective entity to supply invoice data over a communications network, the invoice data being arranged in a plurality of data fields being preset in response to respective contractual terms applicable to any given type of transaction and avoid introducing incorrect invoice data;
collecting transaction-fulfillment data indicative of whether respective products and/or services covered by respective ones of said distinct types of business transactions actually meet the respective contractual terms applicable to each distinct transaction;
coupling each distinct transaction-processing module to share a common accounts payables module for accessing the database with rules prescribing the payment or lack thereof for each distinct type of transaction in view of the fulfillment data for each respective distinct transaction, the accounts payables module configured to relate the supplied invoice data relative to the fulfillment data and to the rules prescribing the payment or lack thereof for each distinct type of transaction to determine an appropriate action regarding disposition of each respective invoice; and
configuring an accounts payables database in said accounts payable module configured to provide to each entity respective status of account information regarding any distinct types of business transactions transacted by any respective entity with the purveyor of the goods, said accounts payables database available to each entity through the communications network.

6. The computerized method of claim 5 further comprising posting a ledger comprising data indicative of accounts payable transactions, the ledger made available through the communications network.

7. The computerized method of claim 5 wherein one of the distinct transaction-processing modules is configured to manage payment of services based on the billable time of a service provider by:
providing a database configured to store a respective billing profile for each service provider, wherein the billing profile includes a respective identifier for uniquely associating each respective billing profile to each service provider, and information indicative of at least a first manager responsible for managing billing information of the service provider based on account number information;
providing a Web page including a link configured to link over the communications network the service provider to an electronic time sheet including a plurality of data fields for entering billable time for an identified period of time;
upon completion of the electronic time sheet by the service provider, providing each electronic time sheet over the communications network to each first manager to indicate in a respective data field of the time sheet whether or not each first manager approves the billing information of that service provider corresponding to a respective account number for the identified period of time;
transmitting each approved electronic time sheet to an accounts payable module including a rule base with rules prescribing the payment of services;
processing each approved electronic time sheet in the accounts payable module using the billing profile of the service provider and the rule base to generate an electronic invoice and issue electronic payment and remittance information thereof in compliance with the rules in the rule base for the services performed by the service provider over the identified period of time.

8. The method of claim 7 wherein the billing profile for each service provider includes billing information selected from the group comprising standard billable rate, overtime billable rate, and account number information regarding each project in which the service provider participates.

9. The method of claim 7 wherein the rule base includes a predefined time limit to be measured from the date of performance of the services and beyond which time limit no time sheet is accepted for payment.

10. The method of claim 7 wherein the rule base includes a due date for determining when to issue payment for the services performed by the service provider.

11. The method of claim 7 wherein the rule base includes a payee account number which is electronically credited for the services performed by the service provider.

12. The method of claim 7 wherein the manager information further indicates a second manager responsible for managing billing information of the service provider in addition to the first manager.

13. The method of claim 7 wherein, in the event the time sheet is rejected by the responsible manager, providing a data field for entering comments regarding the basis of the rejection.

14. The method of claim 13 wherein, in the event the time sheet is rejected by the responsible manager, transmitting a message to the service provider indicative of the rejection, said message including the comments regarding the basis of the rejection.

15. The method of claim 7 further comprising sending reminder information to any responsible manager regarding any unreviewed time sheets by that manager.

16. A computerized system for cohesively managing account payables accrued by a purveyor of goods through a plurality of distinct types of business transactions with a plurality of generally independent entities transacting with the purveyor of goods, the system comprising:
a plurality of distinct transaction-processing modules, each configured to process a distinct type of business transaction that may arise in the operations of a purveyor of the goods;
a database with rules prescribing the payment or lack thereof for each distinct type of business transaction based on whether transaction-fulfillment terms applicable to each distinct transaction are met;
a user-interface for each respective entity to supply invoice data over a communications network, the invoice data being arranged in a plurality of data fields being preset in response to respective contractual terms applicable to any given type of transaction and avoid introducing incorrect invoice data;
a database for collecting transaction-fulfillment data indicative of whether respective products and/or services covered by respective ones of said distinct types of business transactions actually meet the respective contractual terms applicable to each distinct transaction;
each distinct transaction-processing module being coupled to share a common accounts payables module for accessing the database with rules prescribing the payment or lack thereof for each distinct type of transaction in view of the fulfillment data for each respective distinct transaction, the accounts payables module configured to relate the supplied invoice data relative to the fulfillment data and to the rules prescribing the payment or lack thereof for each distinct type of transaction to determine an appropriate action regarding disposition of each respective invoice; and
an accounts payables database in said accounts payable module configured to provide to each entity respective status of account information regarding any distinct types of business transactions transacted by any respective entity with the purveyor of the goods, said accounts payables database available to each entity through the communications network.

17. The system of claim 16 further comprising a module for posting a ledger comprising data indicative of accounts payable transactions, the ledger made available through the communications network.

18. The system of claim 16 wherein one of the distinct transaction-processing modules is configured to manage payment of services based on the billable time of a service provider.

19. The system of claim 16 wherein the module configured to manage payment of services based on the billable time of a service provider comprises:
a database configured to store a respective billing profile for each service provider, wherein the billing profile includes a respective identifier for uniquely associating each respective billing profile to each service provider, and information indicative of at least a first manager responsible for managing billing information of the service provider based on account number information;
an electronic time sheet module configured to provide a Web page including a link configured to link over the communications network the service provider to an electronic time sheet including a plurality of data fields for entering billable time for an identified period of time, wherein, upon completion of the electronic time sheet by the service provider, the module provides each electronic time sheet over the communications network to each first manager to indicate in a respective data field of the time sheet whether or not each first manager approves the billing information of that service provider corresponding to a respective account number for the identified period of time; and
an accounts payable module responsive to data file feeds of approved electronic time sheets, said accounts payable module including a rule base with terms prescribing the management of the payment of services, said accounts payable module further including a processor configured to process each approved electronic time sheet using the billing profile of the service provider and the rule base to generate an electronic invoice and issue payment with remittance information thereof in compliance with the terms in the rule base for the services performed by that service provider over the identified period of time.

20. The system of claim 19 wherein the billing profile for each service provider includes billing information selected from the group comprising standard billable rate, overtime billable rate, and account number information regarding each project in which the service provider participates.

21. The system of claim 19 wherein the rule base includes a predefined time limit to be measured from the date of performance of the services and beyond which time limit no time sheet is accepted for payment.

22. The system of claim 19 wherein the rule base includes a due date for determining when to issue payment for the services performed by the service provider.

23. The system of claim 19 wherein the rule base includes a payee account number which is electronically credited for the services performed by the service provider.

24. The system of claim 19 wherein the manager information further indicates a second manager responsible for managing billing information of the service provider in the absence of the first manager.

25. The system of claim 19 wherein, in the event the time sheet is rejected by the responsible manager, providing a data field for entering comments regarding the basis of the rejection.

26. The system of claim 19 wherein, in the event the time sheet is rejected by the responsible manager, transmitting a message to the service provider indicative of the rejection, said message including the comments regarding the basis of the rejection.

27. The system of claim 19 further comprising sending reminder information to any responsible manager regarding any unreviewed time sheets by that manager.
